(19) United States
(12) Patent Application Publication
(10) Pub. No.: US 2009/0256986 A1
(43) Pub. Date: Oct. 15, 2009

(54) PIXEL STRUCTURE AND REPAIRING METHOD THEREOF

(75) Inventors: Chien-Ming Chen, Taipei County (TW); Yuan-Hao Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/334,511

(22) Filed: Dec. 14, 2008

(30) Foreign Application Priority Data
Apr. 9, 2008 (TW) 97112824

(51) Int. Cl. G02F 1/133; G02F 1/13

(52) U.S. Cl. 349/54; 349/192

(57) ABSTRACT

A pixel structure includes a scan line, a gate, a common line, a first dielectric layer, a channel layer, a source, a drain, a data line, a capacitance coupling electrode (CCE), a second dielectric layer and a pixel electrode. The gate, the common line and the scan line are disposed on the substrate, and the gate is electrically connected to the scan line. The common line has at least one first opening, and at least a portion of the first opening is located between the data line and the CCE. The channel layer is disposed on the first dielectric layer above the gate. The source and the drain are disposed on the channel layer. The CCE is disposed on the first dielectric layer above the common line and electrically connected to the drain. The pixel electrode is disposed on the second dielectric layer, and electrically connected to the CCE.

### CROSS-REFERENCE TO RELATED APPLICATION

This application claims the priority benefit of Taiwan application serial no. 97112824, filed on Apr. 9, 2008. The entirety of the above-mentioned patent application is hereby incorporated by reference herein and made a part of specification.

### BACKGROUND OF THE INVENTION

1. Field of the Invention

The present invention relates to a pixel structure and a repairing method thereof, in particularly, to a pixel structure that is easy to be repaired and a repairing method thereof.

2. Description of Related Art

The highly developed multimedia technology in the current society relies much on the progress of the semiconductor or display devices. Among displays, thin film transistor liquid crystal displays (TFT-LCD) having advantages of high definition, high space utilization, low power consumption, and non-radiation have gradually become mainstream products in the market. A common TFT-LCD is mainly formed by a TFT array substrate, a counter substrate, and a liquid crystal layer sandwiched there-between. The TFT array substrate mainly includes a substrate, scan lines, data lines, and pixel structures arranged in arrays on the substrate. The scan line and the data line transmit signals to corresponding pixel structures, so as to achieve the purpose for displaying. Generally speaking, each pixel structure has a storage capacitor (Cst) for assisting the pixel structure to achieve the purpose for displaying.

US Patent No. U.S. Pat. No. 7,057,207 has disclosed a pixel structure, in which a storage capacitance electrode is divided into three sub-electrodes, and the three sub-electrodes are electrically connected to the drain respectively. When short circuit occurs between the data line and one of the sub-electrodes due to metal residuals or foreign substance, the operator separates the sub-electrode and the drain by laser cutting. However, once the sub-electrode and the drain are separated, the storage capacitance, aperture ratio, and liquid crystal alignment of the pixel structure are adversely affected, thereby degrading the display quality.

### SUMMARY OF THE INVENTION

Accordingly, the present invention is directed to a pixel structure, which has the advantage of being easy to be repaired.

The present invention is further directed to a repairing method, suitable for repairing the pixel structure of the present invention, so as to enhance the product yield.

The present invention provides a pixel structure, which is suitable to be disposed on a substrate. The pixel structure of the present invention includes a scan line, a gate, a common line, a first dielectric layer, a channel layer, a source, a drain, a data line, a capacitance coupling electrode, a second dielectric layer, and a pixel electrode. The gate and the scan line are disposed on the substrate and electrically connected together. In addition, the common line has at least one first opening, and is disposed on the substrate. The first dielectric layer covers the scan line, the gate, and the common line. The channel layer is disposed on the first dielectric layer above the gate. The source and the drain are disposed on the channel layer. The data line is disposed on the first dielectric layer, and the data line is electrically connected to the source. In addition, the capacitance coupling electrode is disposed on the first dielectric layer above the common line and electrically connected to the drain. At least a portion of the first opening of the common line is located between the data line and the capacitance coupling electrode. The second dielectric layer covers the source, the drain, and the data line. The pixel electrode of the present invention is disposed on the second dielectric layer, and electrically connected to the capacitance coupling electrode.

In an embodiment of the present invention, the common line further includes a second opening, and at least a portion of the second opening is located between the capacitance coupling electrode and an adjacent data line.

In an embodiment of the present invention, the second dielectric layer has a contact window for exposing a portion of the capacitance coupling electrode, and the pixel electrode is electrically connected to the capacitance coupling electrode through the contact window.

The present invention provides a repairing method, suitable for repairing the pixel structure. When the data line is connected to the capacitance coupling electrode, the repairing method of the present invention includes cutting a connection portion between the data line and the capacitance coupling electrode through the first opening.

In an embodiment of the present invention, a process for cutting the connection portion between the data line and the capacitance coupling electrode includes laser cutting.

In an embodiment of the present invention, the repairing method further includes cutting a connection portion between the adjacent data line and the capacitance coupling electrode through a second opening.

In an embodiment of the present invention, a process for cutting the connection portion between the adjacent data line and the capacitance coupling electrode includes laser cutting.

Since the first opening on the common line of the present invention is located between the data line and the capacitance coupling electrode, if abnormal short circuit occurs between the data line and the capacitance coupling electrode, the operator may separate the data line and the capacitance coupling electrode through the first opening by laser cutting. In addition, if abnormal short circuit occurs between the adjacent data line and the capacitance coupling electrode, the operator may separate the adjacent data line and the capacitance coupling electrode through the second opening by laser cutting. The pixel structure of the present invention is easy to be repaired, and the storage capacitance and aperture ratio of the pixel structure after repairing will not be adversely affected.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a pixel structure according to an embodiment of the present invention.

FIG. 2 is a schematic cross-sectional view taken along sectional lines A-A′ and B-B′ of FIG. 1.

FIG. 3 is a schematic view of a defective pixel structure according to the present invention.

FIG. 4 is a schematic view of a repaired pixel structure according to the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

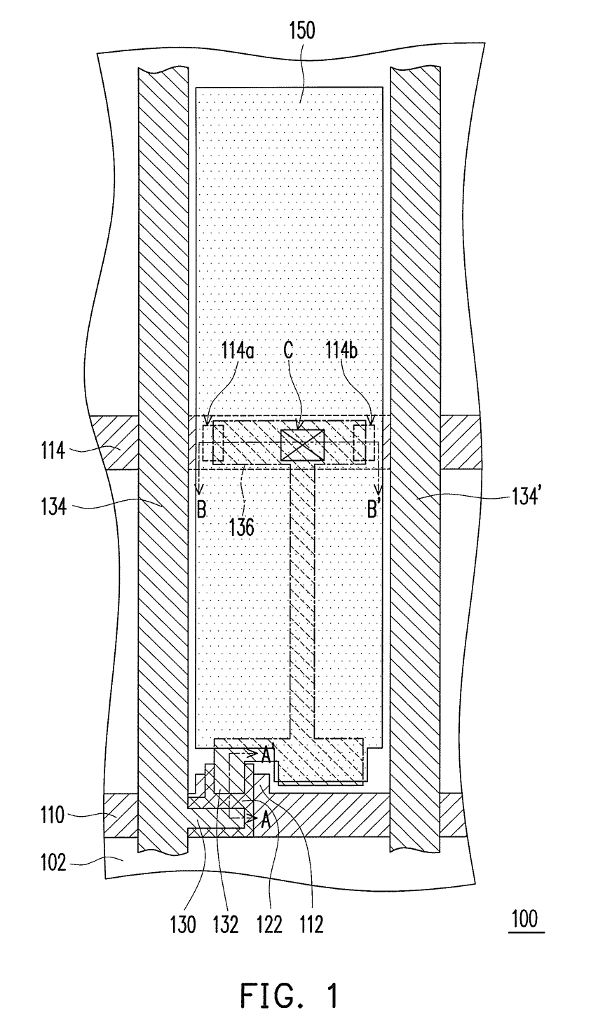

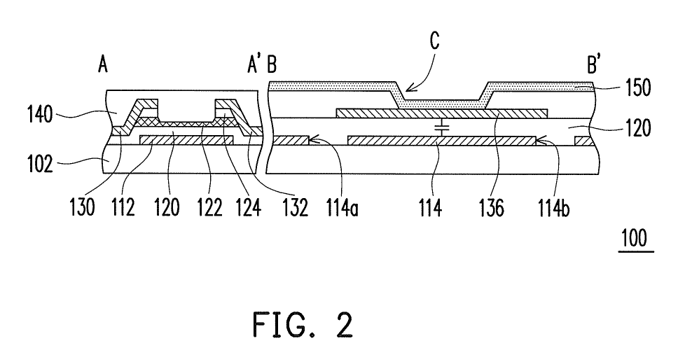

FIG. 1 is a top view of a pixel structure according to an embodiment of the present invention. FIG. 2 is a schematic cross-sectional view taken along sectional lines A-A′ and B-B′ of FIG. 1. In order to simplify the figure, the dielectric layer is omitted in FIG. 1, but the dielectric layer in the pixel structure is clearly shown in FIG. 2. Referring to FIGS. 1 and 2, the pixel structure 100 is suitable to be disposed on a substrate 102, and the pixel structure 100 includes a scan line 110, a gate 112, a common line 114, a first dielectric layer 120, a channel layer 122, a source 130, a drain 132, a data line 134, a capacitance coupling electrode 136, a second dielectric layer 140, and a pixel electrode 150. The scan line 110, the gate 112, and the common line 114 are all disposed on the substrate 102, and the gate 112 is electrically connected to the scan line 110. In practice, the scan line 110, the gate 112, and the common line 114 may be integrally formed on the substrate 102 through a same masking process.

Particularly, the common line 114 has at least one first opening 114a. It may be known from FIG. 1 that at least a portion of the first opening 114a of the common line 114 is located between the data line 134 and the capacitance coupling electrode 136. In an embodiment, a second opening 114b may be selectively formed on the common line 114. At least a portion of the second opening 114b is located between the capacitance coupling electrode 136 and another adjacent data line 134′.

In addition, the first dielectric layer 120, as shown in FIG. 2, covers the scan line 110, the gate 112, and the common line 114. The channel layer 122 is disposed on the first dielectric layer 120 above the gate 112. Furthermore, the source 130 and the drain 132 are disposed on the channel layer 122. In order to reduce the contact impedance between the metal material and the semiconductor material, an ohmic contact layer 124 is formed between the channel layer 122 and the source 130 and between the channel layer 122 and the drain 132. In another aspect, the data line 134 is disposed on the first dielectric layer 120, and electrically connected to the source 130. As shown in FIG. 2, the capacitance coupling electrode 136 is disposed on the first dielectric layer 120 above the common line 114, so as to form a storage capacitor (Cst).

It should be noted that the drain 132 is electrically connected to the capacitance coupling electrode 136. As shown in FIG. 1, the capacitance coupling electrode 136 may be formed by the portion extending from the drain 132. In practice, the source 130, the drain 132, the data line 134, and the capacitance coupling electrode 136 may be integrally formed through a same masking process. In addition, the second dielectric layer 140 covers the source 130, the drain 132, the data line 134, and the capacitance coupling electrode 136. The pixel electrode 150 is disposed on the second dielectric layer 140, and electrically connected to the capacitance coupling electrode 136 through a contact window C. Till now, the pixel structure 100 of the present invention has been substantially introduced. Then, the repairing method of one embodiment of this present invention used for repairing the defective pixel structure will be illustrated below.

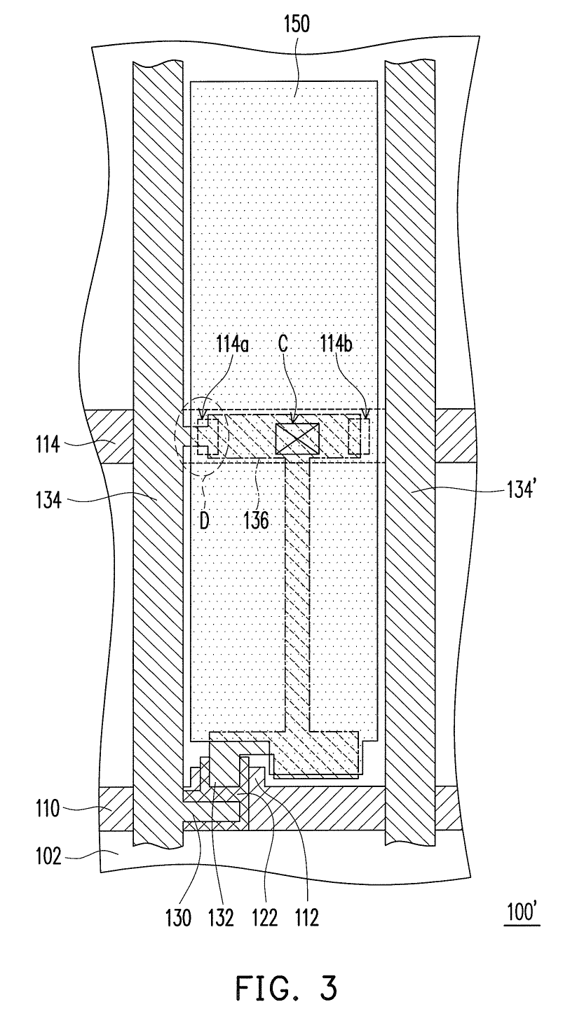

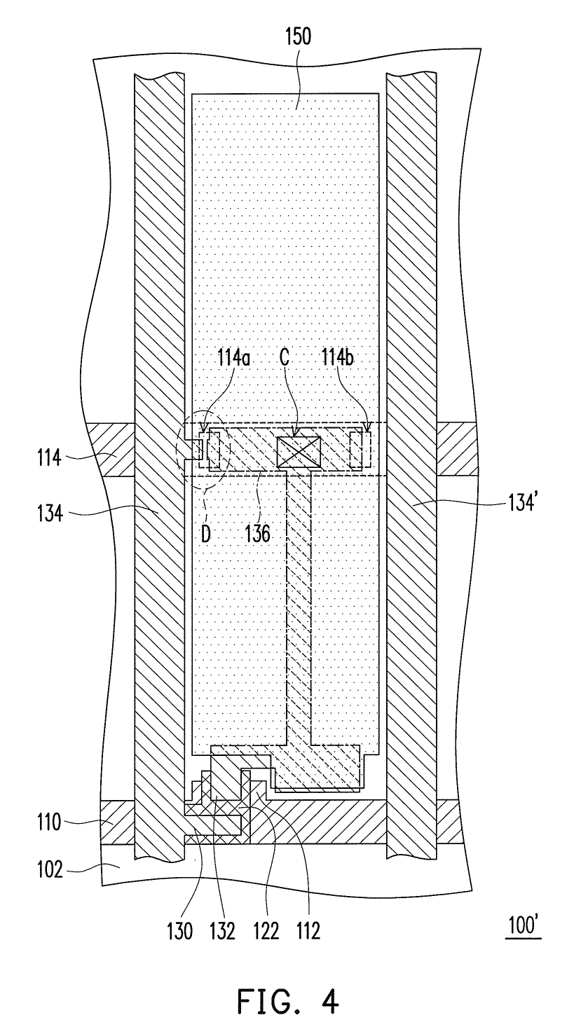

FIG. 3 is a schematic view of a defective pixel structure according to the present invention. Referring to FIG. 3, when a short circuit occurs (at D as shown in FIG. 3) between the data line 134 and the capacitance coupling electrode 136 due to the metal residuals or foreign substance generated in the manufacturing process, the repairing method includes separating the connection portion between the data line 134 and the capacitance coupling electrode 136 through the first opening 114a by, for example, laser cutting. As shown in FIG. 4, after the pixel structure 100′ is repaired, the data line 134 and the capacitance coupling electrode 136 are separated, and the size of the capacitance coupling electrode 136 will not be reduced after repairing, thus avoiding the problem in the conventional pixel structure that the storage capacitance will be reduced after the pixel structure is repaired.

It should be noted that the first opening 114a of the common line 114 can effectively prevent the pixel electrode 150 from being fused with the common line 114 after the pixel structure 100′ has been repaired. In another aspect, after the pixel structure 100′ is repaired, the aperture ratio and the liquid crystal alignment will not be adversely affected. In addition, if an abnormal short circuit occurs between an adjacent data line 134′ and the capacitance coupling electrode 136, the repairing method further includes cutting a connection portion between the adjacent data line 134′ and the capacitance coupling electrode 136 through the second opening 114b.

In view of the above, since the first opening of the common line of the present invention is located between the data line and the capacitance coupling electrode, when an abnormal short circuit occurs between the data line and the capacitance coupling electrode, the operator separates the data line and the capacitance coupling electrode through the first opening by laser cutting. Furthermore, when an abnormal short circuit occurs between the adjacent data line and the capacitance coupling electrode, the operator separates the adjacent data line and the capacitance coupling electrode through the second opening by laser cutting. The pixel structure of the present invention may be easily repaired by the repairing method of the present invention, and the storage capacitance and the aperture ratio of the pixel structure will not be adversely affected after the pixel structure is repaired.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, suitable to be disposed on a substrate, comprising:
a scan line;
a gate, disposed together with the scan line on the substrate, and electrically connected to the scan line;
a common line, having at least one first opening, and disposed on the substrate;
a first dielectric layer, covering the scan line, the gate, and the common line;
a channel layer, disposed on the first dielectric layer above the gate;
a source and a drain, disposed on the channel layer;
a data line, disposed on the first dielectric layer, and electrically connected to the source;
a capacitance coupling electrode, disposed on the first dielectric layer above the common line, and electrically connected to the drain, wherein at least a portion of the first opening of the common line is located between the data line and the capacitance coupling electrode;
a second dielectric layer, covering the source, the drain, and the data line; and
a pixel electrode, disposed on the second dielectric layer, and electrically connected to the capacitance coupling electrode.

2. The pixel structure according to claim 1, wherein the common line further comprises a second opening, and at least a portion of the second opening is located between the capacitance coupling electrode and another adjacent data line.

3. The pixel structure according to claim 1, wherein the second dielectric layer has a contact window for exposing a portion of the capacitance coupling electrode, and the pixel electrode is electrically connected to the capacitance coupling electrode through the contact window.

4. A repairing method, suitable for repairing the pixel structure according to claim 1, when the data line is connected to the capacitance coupling electrode, the repairing method comprising:
cutting a connection portion between the data line and the capacitance coupling electrode through the first opening.

5. The repairing method according to claim 4, wherein a process for cutting the connection portion between the data line and the capacitance coupling electrode includes laser cutting.

6. The repairing method according to claim 1, further comprising cutting a connection portion between another adjacent data line and the capacitance coupling electrode through the second opening when the adjacent data line is connected to the capacitance coupling electrode.

7. The repairing method according to claim 6, wherein a process for cutting the connection portion between the adjacent data line and the capacitance coupling electrode includes laser cutting.
